(19) United States
(12) Patent Application Publication
(10) Pub. No.: US 2023/0237177 A1
(43) Pub. Date: Jul. 27, 2023

(54) CONTENT AWARE STORAGE OF CLOUD OBJECT STORAGE

(71) Applicant: International Business Machines Corporation, Armonk, NY (US)

(72) Inventors: Shikhar Kwatra, San Jose, CA (US); Afroz Khan I, Davanagere (IN); Hemant Kumar Sivaswamy, Pune (IN); Piyush Shivam, Austin, TX (US)

(21) Appl. No.: 17/582,592

(22) Filed: Jan. 24, 2022

(51) Int. Cl. G06F 21/62; G06F 21/60; G06F 16/21

(52) U.S. Cl. CPC G06F 21/6218; G06F 21/602; G06F 16/214

(57) ABSTRACT

A pending data migration is detected, that is related to a set of one or more data blobs. The set of data blobs are stored on a source cloud object data store. The set of data blobs are retrieved, from the source cloud object data store. A security requirement for the set of data blobs is identified based on the set of data blobs and based on the source cloud object data store. A set of one or more potential target cloud object data stores from a set of additional cloud object data stores is determined. The set of data blobs is assigned, in response to the determination, to a first potential target cloud object data store of the set of potential target cloud object data stores. The assignment is based on the security requirement.

### BACKGROUND

The present disclosure relates to computer storage, and more specifically, to cloud object storage provisioning and migration.

Computer storage is a fundamental element of computer science and engineering. Computer storage includes instances where users store data in many places and utilize the stored data to perform calculations and execute research related to the subject matter of the stored data. Computer storage has increasingly gone online, to remote hosting solutions that store data separately from the owner of the data. Security of the data stored online is more difficult to perform.

### SUMMARY

According to embodiments, disclosed are a method, system, and computer program product.

A pending data migration is detected, that is related to a set of one or more data blobs. The set of data blobs are stored on a source cloud object data store. The set of data blobs are retrieved, from the source cloud object data store. A security requirement for the set of data blobs is identified. The identification is based on the set of data blobs and based on the source cloud object data store. A set of one or more potential target cloud object data stores from a set of additional cloud object data stores is determined in response to the pending data migration. The determination is based on the security requirement. The set of data blobs is assigned, in response to the determination, to a first potential target cloud object data store of the set of potential target cloud object data stores. The assignment is based on the security requirement.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts the representative major components of an example computer system that may be used, in accordance with some embodiments of the present disclosure;

FIG. 2 depicts a cloud computing environment according to an embodiment of the present invention;

FIG. 3 depicts abstraction model layers according to an embodiment of the present invention;

FIG. 4 depicts a system of securely migrating data between cloud object stores, consistent with some embodiments of the disclosure; and

FIG. 5 depicts an example method of performing data migration of cloud objects, consistent with some embodiments of the disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to computer storage; more particular aspects relate to cloud object storage provisioning and migration. While the present disclosure is not necessarily limited to such applications, various aspects of the disclosure may be appreciated through a discussion of various examples using this context.

With the exponential growth in usage of computing devices, the usage and computer data (“data”) requirements for computer storage has also increased. For instance, laptops, handheld personal digital assistants (“PDAs”), smartphones, and other computing devices take pictures, share messages, exchange songs and videos, and measure and observe data in various environments. Further, computing devices are increasingly personal in nature and also capture and/or generate increasingly personal data. For example, a smart watch or a wearable health device may capture or generate (consequently from captured data) personal health information of a user. Yet further are Internet of things devices (“IoT”) that also create a rather large amount of data (e.g., sensor data about atmospheric or weather conditions in certain areas, or communication events or status from connected devices in a home or commercial setting).

All of this data creation has created increasing amounts of computer storage needs. The price of computer storage on devices has lessened, but not at the speed of the new creation and sharing of data. Consequently, data created by users has to be dealt with in some technological manner. In many cases, users do not have the time and do not have the desire to just delete data. Instead of permanent deletion, users may choose to store data in another fashion. In such fashion, as computer data generated goes through its life cycle, at one point in time it needs to be either backed up or archived. Increasingly, users and computer administrators have turned to object storage techniques for storing data that is accessible online.

Cloud object Storage and object-based storage (interchangeably “object storage”) are techniques of increasing popularity for the offloading, archiving, or backing up of computer data. Object storage can provide certain features such as a relatively unlimited amount of storage, relatively lower cost, and the ability to store unstructured data without worrying too much about the hierarchy. Further, object storage may also facilitate improved data resiliency and disaster recovery. Object storage may operate by storing computer data as unstructured data. Unstructured data may be data that is stored in a manner that does not conform to, or cannot be organized easily in, a traditional manner. For example, a structured data storage technique may include rows and columns of a relational database. In another example, files, folders, directories, logical drives, and/or logical devices may all be part of a structured data storage technique of a computer operating system.

As object storage has grown in popularity, there is an increasing need to categorize and secure data. Specifically, with the increased popularity and relatively inexpensive nature of object storage, a plethora of data types have come to be stored in object storage. Each of the data types may have a differing security requirement imposed upon it. In one example, expectations of users have altered the different security requirements. A user may have photos of friends and family stored along with copies of public records or bookmarks to websites. The users may have an expectation that the photos are kept at a higher level of security at all times. Additionally, a user may expect that lower-security or public items of record are kept as cheaply as possible. For example, a user may prefer to store a copy of a publicly available recipe found on a website, but the user may not expect that the recipe is stored in a secure or processing intensive manner. In another example, secure or encrypted cloud object storage may have additional costs in computing resources, such as a faster processor for performing relatively advanced encryption techniques. A user may place a low priority on acquiring or retaining the costly computing resources, and the user may permit or volunteer that the public information may be kept in its raw format.

In addition to personal choices, certain regions or jurisdictional requirement may place differing requirements on storage of data, regardless of its format (including object storage). In detail, various regions and nations may have differing privacy and data security laws. In some instances, dozens of differing states may each have differing laws on how data is stored in those states. Certain regions may require that computer systems consider the privacy of user data regardless of how that data is created and stored.

Further, contracts between organizations may specify a certain standards-based security level that confirms to a predetermined security level. For example, certain organizations have specified standards for encryption and other security of data that includes predefined “low”, “medium”, and “high” security requirements. As these organizations work together, or enter into agreements with each other, they place technical requirements on the processing, storage, and handling of computer data. The technical requirements of the contract may not disappear as data changes place or type of storage. For example, data that is initially marked as “high” security data, does not become lower security data if it is moved from one computer system to another.

There can be issues with computer storage and data storage when it relates to various object storage techniques. Specifically, as data is created by users and/or organizations, the data may be initially stored with a certain security level that may not be easily maintained as data is migrated. In a first example, a first dataset may initially be created with a certain computer security requirement. The first dataset may be created by an operating system or a relational database. The first dataset may be secured with a password in a password protected folder. During the migration to cloud object storage, the first dataset, the password protected folder, and the password may all be converted to object storage. As the object storage stores each of the elements (the first dataset, the folder, the password) as peer objects, the security may not be preserved by the migration. In a second example, a second dataset may be stored on a source cloud object data store. The source cloud object data store may be operating in a first region of a first nation. During storage the second dataset may be migrated to another location at direction of an entity, such as the user, a vendor of a data store, or an organization. The migration may be to a target cloud object data store that is located in another region in the first nation. The migration may include the second dataset being stored in a less secure manner by the target cloud object data store.

Content aware storage of cloud object storage (“CASC”) may provide improvements in the data security techniques. Specifically, CASC may operate to identify one or more security requirements of cloud object storage and object-based storage (“object storage”) (e.g., a set of data blobs) that are related to a pending data migration between various data stores. A data store may include one or more servers in a data center or other physical location that is part of a region and or zone (e.g., a cloud data store). Data blobs may be in the format of object storage that includes a set of non-hierarchical data. In some embodiments, the data blobs may also include metadata and a unique identifier. The pending data migration may be located on a source cloud object data store (“source cloud”). The pending data migration may be directed to a target cloud object data store (“target cloud”). CASC may operate to identify the security requirement of the data blobs based on the content of the data blobs. The CASC may also determine, such as based on the content or metadata, a security requirement of various data blobs and may classify the migration and/or the data blobs with a predefined security impact level. The predefined security requirement may include various levels or thresholds, such as low, moderate, and/or high security compliance as a requirement for any potential target cloud.

CASC may further determine a set of potential target clouds and assign, based on the determination, and further based on the security requirement, a target cloud from the set of potential target clouds. Specifically, CASC may determine potential target clouds by identification of various worker nodes, such as their security practices (e.g., security level of a current operation of a given worker node) and computation resources (e.g., security a worker node is capable of performing). In some embodiments, the CASC may assign the entire pending data migration to a potential target cloud of the set of potential target clouds. In some embodiments, the CASC may assign some of the data blobs of a pending data migration to a potential target cloud of the set of potential target clouds.

The CASC may operate based on one or more regulation requirements. Specifically, a regulation requirement may be a law, regulation, or any other relevant rule of a particular predefined location or regulation body. A predefined location may be a state, jurisdiction, nation, or other defined location where a data store and/or data center is located. A regulation body may be an actor, such as a company, government, entity, or other particular rule-making body that defines the storage and security practices related to various data storage (e.g., General Data Protection Regulation of the European Union (“GDPR”), Health Insurance Portability and Accountability Act of the United States (“HIPAA”), Federal Risk and Authorization Management Program (“FedRAMP”)). One or more rules may be stored and/or defined and include predefined levels of security, such as low, medium, and/or high security. The predefined levels of security may include the type of encryption, the hardware speeds, the type of passwords, the number of authentication factors, or other requirements for storing data. The predefined levels of security may dictate information regarding security practices without specific reference or definition of cloud object storage or other object storage. For example, the regulation requirements may dictate that all “user data” must be stored in an encrypted fashion while being stored in a first nation.

The CASC may reduce the computing resources needed for storage of cloud object storage. For example, a first set of data blobs may be stored on a first source cloud that operates in a first region. The first source cloud may operate with a relatively high or enhanced level of security due to restrictions related to regulation requirement. CASC may identify a data migration from a first location in a first state to a second location that is outside of the first state.

The second location may be a data center that is in another country that is not associated with or affiliated with any regulation requirements of the first state. CASC may operate to identify a change (e.g., lessening, lowering, or reduction) in a security requirement for the first migration and may select a less computationally intensive worker node and/or target cloud in the second location.

The CASC may increase the security data blobs that are migrated between various object storages. For example, a user may initially upload data to a first cloud vendor (aka, a source cloud). The first cloud vendor may by default store data blobs at a predefined security level, such as a relatively moderate security level. The data may include photos that are stored in the form of object storage at the first cloud vendor. The user may indicate in preferences that they prefer at least moderate security levels for storage of media, such as photos. Later the user may wish to perform a migration between the first cloud vendor and a second cloud vendor (e.g., if the first cloud vendor is ceasing operations). The second cloud vendor may default to storing data blobs (and all object data) at a relatively low security level, including photos. CASC may operate to preserve the security of the data while it is the form of object storage by identifying the media type, such as by scanning the content and/or metadata of the user's data blobs in the source cloud of the first cloud vendor. Upon identifying the type of data in the data blobs of the source cloud and the operation, CASC may operate by assigning one or more worker nodes or target cloud data stores in the second cloud vendor that conform to the same security level as the source cloud vendor. The CASC may assign the particular worker nodes and/or target clouds, despite those entities not being the default operating entities of the second cloud vendor.

The identifying, by CASC, of the security requirements of a pending data migration may be based on one or more artificial intelligence operations. For example, CASC may operate to perform natural language processing (“NLP”) and/or machine learning (“ML”) techniques. In some embodiments, CASC may perform artificial intelligence such as performing NLP and/or ML on the data blobs that are part of a pending migration to identify a security requirement. In some embodiments, CASC may perform artificial intelligence to identify the proper worker node, such as performing NLP and/or ML to identify security settings of various potential target clouds.

In at least some embodiments, CASC, the systems, computer program products, and methods described herein use an artificial intelligence platform. “Artificial Intelligence” (AI) is one example of cognitive systems that relate to the field of computer science directed at computers and computer behavior as related to humans and man-made and natural systems. Cognitive computing utilizes self-teaching algorithms that use, for example, and without limitation, data analysis, visual recognition, behavioral monitoring, and natural language processing (NLP) to solve problems and optimize human processes. The data analysis and behavioral monitoring features analyze the collected relevant data and behaviors as subject matter data as received from the sources as discussed herein. As the subject matter data is received, organized, and stored, the data analysis and behavioral monitoring features analyze the data and behaviors to determine the relevant details through computational analytical tools which allow the associated systems to learn, analyze, and understand human behavior, including within the context of the present disclosure. With such an understanding, the AI can surface concepts and categories, and apply the acquired knowledge to teach the AI platform the relevant portions of the received data and behaviors. In addition to analyzing human behaviors and data, the AI platform may also be taught to analyze data and behaviors of man-made and natural systems.

In addition, cognitive systems such as AI are able to make decisions based on information, which maximizes the chance of success in a given topic or setting. More specifically, AI is able to learn from a dataset, including behavioral data, to solve problems and provide relevant recommendations. For example, in the field of artificial intelligent computer systems, machine learning (ML) systems process large volumes of data, seemingly related or unrelated, where the ML systems may be trained with data derived from a database or corpus of knowledge, as well as recorded behavioral data. The ML systems look for, and determine, patterns, or lack thereof, in the data, “learn” from the patterns in the data, and ultimately accomplish tasks without being given specific instructions. In addition, the ML systems, utilizes algorithms, represented as machine proces sable models, to learn from the data and create foresights based on this data. More specifically, ML is the application of AI, such as, and without limitation, through creation of neural networks that can demonstrate learning behavior by performing tasks that are not explicitly programmed. Deep learning is a type of neural-network ML in which systems can accomplish complex tasks by using multiple layers of choices based on output of a previous layer, creating increasingly smarter and more abstract conclusions.

ML learning systems may have different “learning styles.” One such learning style is supervised learning, where the data is labeled to train the ML system through telling the ML system what the key characteristics of a thing are with respect to its features, and what that thing actually is. If the thing is an object or a condition, the training process is called classification. Supervised learning includes determining a difference between generated predictions of the classification labels and the actual labels, and then minimize that difference. If the thing is a number, the training process is called regression. Accordingly, supervised learning specializes in predicting the future.

A second learning style is unsupervised learning, where commonalities and patterns in the input data are determined by the ML system through little to no assistance by humans. Most unsupervised learning focuses on clustering, e.g., grouping the data by some set of characteristics or features. These may be the same features used in supervised learning, although unsupervised learning typically does not use labeled data. Accordingly, unsupervised learning may be used to find outliers and anomalies in a dataset, and cluster the data into several categories based on the discovered features.

Semi-supervised learning is a hybrid of supervised and unsupervised learning that includes using labeled as well as unlabeled data to perform certain learning tasks. Semi-supervised learning permits harnessing the large amounts of unlabeled data available in many use cases in combination with typically smaller sets of labelled data. Semi-supervised classification methods are particularly relevant to scenarios where labelled data is scarce. In those cases, it may be difficult to construct a reliable classifier through either supervised or unsupervised training. This situation occurs in application domains where labelled data is expensive or difficult obtain, like computer-aided diagnosis, drug discovery, and part-of-speech tagging. If sufficient unlabeled data is available and under certain assumptions about the distribution of the data, the unlabeled data can help in the construction of a better classifier through classifying unlabeled data as accurately as possible based on the documents that are already labeled.

The third learning style is reinforcement learning, where positive behavior is “rewarded: and negative behavior is “punished.” Reinforcement learning uses an “agent,” the agent's environment, a way for the agent to interact with the environment, and a way for the agent to receive feedback with respect to its actions within the environment. An agent may be anything that can perceive its environment through sensors and act upon that environment through actuators. Therefore, reinforcement learning rewards or punishes the ML system agent to teach the ML system how to most appropriately respond to certain stimuli or environments. Accordingly, over time, this behavior reinforcement facilitates determining the optimal behavior for a particular environment or situation.

Deep learning is a method of machine learning that incorporates neural networks in successive layers to learn from data in an iterative manner. Neural networks are models of the way the nervous system of an organism operates. Basic units are referred to as neurons, which are typically organized into layers. The neural network works by simulating a large number of interconnected processing devices that resemble abstract versions of neurons. There are typically three parts in a neural network, including an input layer, with units representing input fields, one or more hidden layers, and an output layer, with a unit or units representing target field(s). The units are connected with varying connection strengths or weights. Input data are presented to the first layer, and values are propagated from each neuron to every neuron in the next layer. At a basic level, each layer of the neural network includes one or more operators or functions operatively coupled to output and input. Output from the operator(s) or function(s) of the last hidden layer is referred to herein as activations. Eventually, a result is delivered from the output layers. Deep learning complex neural networks are designed to emulate how the human brain works, so computers can be trained to support poorly defined abstractions and problems. Therefore, deep learning is used to predict an output given a set of inputs, and either supervised learning or unsupervised learning can be used to facilitate such results.

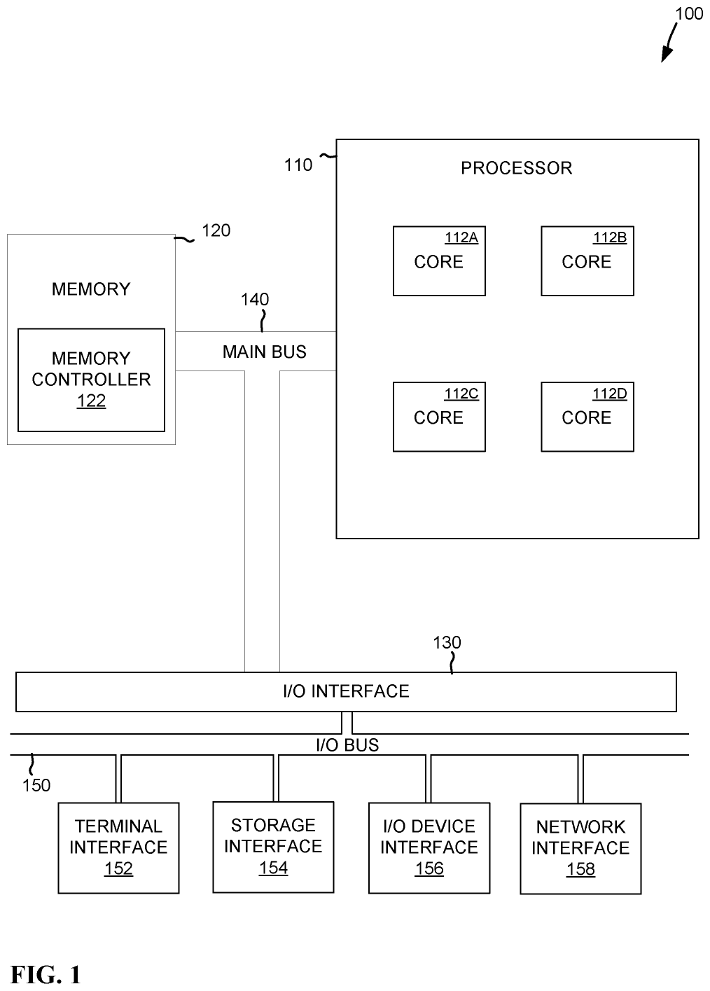

FIG. 1 depicts the representative major components of an example computer system 100 (alternatively, computer) that may be used, in accordance with some embodiments of the present disclosure. It is appreciated that individual components may vary in complexity, number, type, and/or configuration. The particular examples disclosed are for example purposes only and are not necessarily the only such variations. The computer system 100 may include a processor 110, memory 120, an input/output interface (herein I/O or I/O interface) 130, and a main bus 140. The main bus 140 may provide communication pathways for the other components of the computer system 100. In some embodiments, the main bus 140 may connect to other components such as a specialized digital signal processor (not depicted).

The processor 110 of the computer system 100 may be comprised of one or more cores 112A, 112B, 112C, 112D (collectively 112). The processor 110 may additionally include one or more memory buffers or caches (not depicted) that provide temporary storage of instructions and data for the cores 112. The cores 112 may perform instructions on input provided from the caches or from the memory 120 and output the result to caches or the memory. The cores 112 may be comprised of one or more circuits configured to perform one or more methods consistent with embodiments of the present disclosure. In some embodiments, the computer system 100 may contain multiple processors 110. In some embodiments, the computer system 100 may be a single processor 110 with a singular core 112.

The memory 120 of the computer system 100 may include a memory controller 122. In some embodiments, the memory 120 may include a random-access semiconductor memory, storage device, or storage medium (either volatile or non-volatile) for storing data and programs. In some embodiments, the memory may be in the form of modules (e.g., dual in-line memory modules). The memory controller 122 may communicate with the processor 110, facilitating storage and retrieval of information in the memory 120. The memory controller 122 may communicate with the I/O interface 130, facilitating storage and retrieval of input or output in the memory 120.

The I/O interface 130 may include an I/O bus 150, a terminal interface 152, a storage interface 154, an I/O device interface 156, and a network interface 158. The I/O interface 130 may connect the main bus 140 to the I/O bus 150. The I/O interface 130 may direct instructions and data from the processor 110 and memory 120 to the various interfaces of the I/O bus 150. The I/O interface 130 may also direct instructions and data from the various interfaces of the I/O bus 150 to the processor 110 and memory 120. The various interfaces may include the terminal interface 152, the storage interface 154, the I/O device interface 156, and the network interface 158. In some embodiments, the various interfaces may include a subset of the aforementioned interfaces (e.g., an embedded computer system in an industrial application may not include the terminal interface 152 and the storage interface 154).

Logic modules throughout the computer system 100—including but not limited to the memory 120, the processor 110, and the I/O interface 130—may communicate failures and changes to one or more components to a hypervisor or operating system (not depicted). The hypervisor or the operating system may allocate the various resources available in the computer system 100 and track the location of data in memory 120 and of processes assigned to various cores 112. In embodiments that combine or rearrange elements, aspects and capabilities of the logic modules may be combined or redistributed. These variations would be apparent to one skilled in the art.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed. Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases

automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two

or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

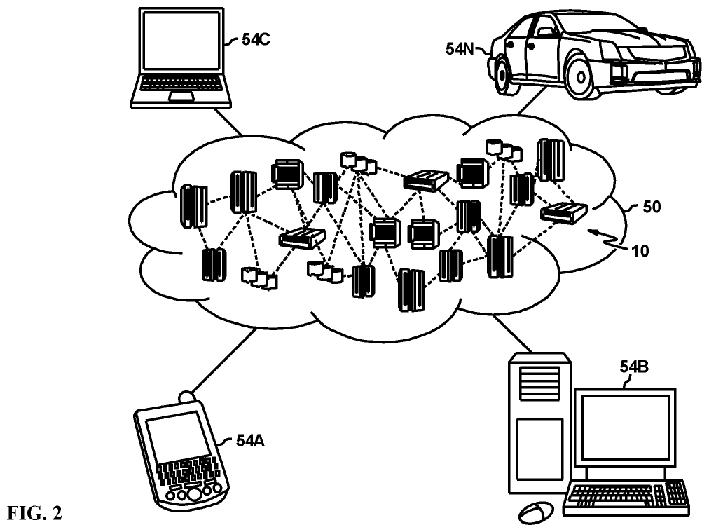

Referring now to FIG. 2, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

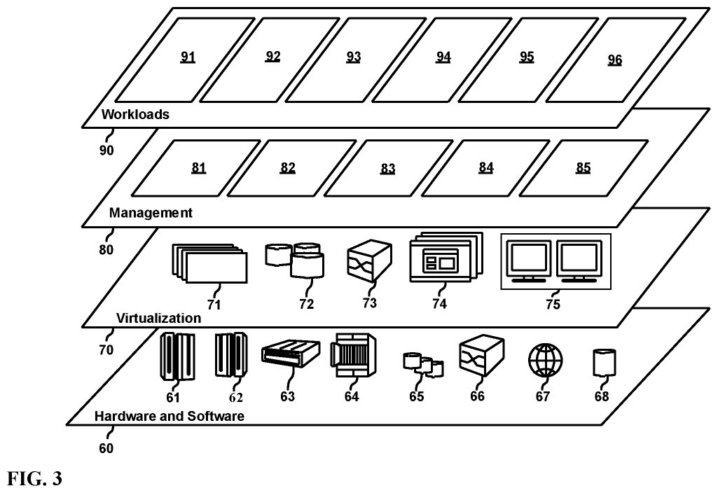

Referring now to FIG. 3, a set of functional abstraction layers provided by cloud computing environment 50 (FIG. 2) is shown. It should be understood in advance that the components, layers, and functions shown in FIG. 3 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68. Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and CASC 96.

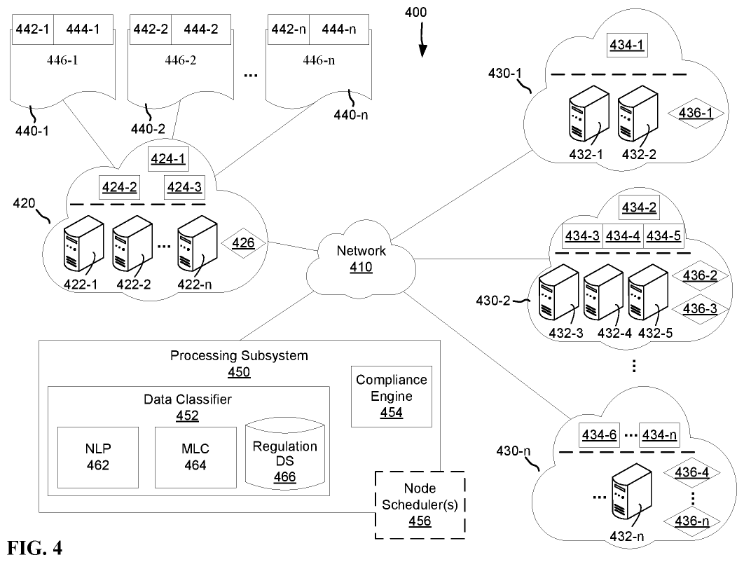

FIG. 4 depicts a system 400 that securely migrates data between cloud object stores, consistent with some embodiments of the disclosure. Specifically, system 400 may be configured to perform CASC against cloud object data that is to be provisioned and/or migrated to various additional cloud data stores. System 400 may include at least the following: a network 410; at least one source cloud object data store (“source cloud”) 420; a set of one or more additional cloud object data stores (“additional clouds”) 430-1, 430-2, up to 430-n (collectively, additional clouds 430); a set of data blobs 440-1, 440-2, up to 440-n (collectively, data blobs 440) (alternatively, object data 440); and a processing subsystem 450.

Network 410 of system 400 may be a communications network configured to facilitate communication between various entities of system 400. Network 410 may be implemented using any number of any suitable physical and/or logical communications topologies. The network 410 can include one or more private or public computing networks. For example, network 410 may comprise a private network (e.g., a network with a firewall that blocks non-authorized external access) that is associated with a particular function or workload (e.g., communication, streaming, hosting, sharing), or set of software or hardware clients. Alternatively, or additionally, network 410 may comprise a public network, such as the Internet. Consequently, network 410 may form part of a data unit network that transmits data in the form of datagrams (e.g., a packet-based network)—for instance, a local-area network, a wide-area network, and/or a global network.

Network 410 may include one or more servers, networks, or databases, and can use one or more communication protocols to transfer data between other components of system 400. Furthermore, although illustrated in FIG. 4 as a single entity, in other examples network 410 may comprise a plurality of networks, such as a combination of public and/or private networks. The communications network 410 can include a variety of types of physical communication channels or “links.” The links can be wired, wireless, optical, and/or any other suitable media. In addition, the communications network 410 can include a variety of network hardware and software (not depicted) for performing routing, switching, and other functions, such as routers, switches, base stations, bridges, or any other equipment that may be useful to facilitate communicating data.

The source cloud 420 and the additional clouds 430 may be various instances of cloud object data stores. In detail, source cloud 420 may include the following: a plurality of hardware servers 422-1, 422, up to 422-n (collectively, hardware servers 422); a set of worker nodes 424-1, 424-2, and 424-3 (collectively, worker nodes 424); and at least one operating regulation (“regulation”) 426. Similarly, the additional clouds 430 may include at least the following: a plurality of hardware servers 432-1, 432-2, 432-3, 432-4, 432-5, up to 432-n (hardware servers 432); a set of worker nodes 434-1, 434-2, 434-3, 434-4, 434-5, 434-6, up to 434-n (worker nodes 434); and a set of operating regulations 436-1, 436-2, 436-3, 436-4, up to 436-n (regulations 436). The additional clouds 430 may be configured in a homogenous manner (e.g., each additional cloud 430 having a similar number of hardware servers 432 and worker nodes 434). In some embodiments, as depicted in FIG. 4, the additional clouds 430 may have a heterogeneous configuration of resources. For example, additional cloud 430-1 may include two hardware servers 432-1 and 432-2, and a single worker node 434-1. Continuing the example, additional cloud 430-2 may include three hardware servers 432-3, 432-4, and 432-5, and further four worker nodes 434-2, 434-3, 434-4, and 434-5.

The hardware servers 422 and 432 may include various physical and/or logical computer systems that are configured to host object data, such as data blobs 440. The worker nodes 424 and 434 may include one or more software elements configured to perform object data storage and retrieval. For instance, each of the worker nodes 424 and 434 may be daemons, jobs, virtual machines, operating systems, containers, processes, threads, or other relevant software constructs. A given hardware server 422 and 432 and/or worker node 424 and 434 may include an attached set of storage devices, such as device drives or network attached storage (not depicted). The regulations 426 and 436 may include one or more specific service level agreements, entity-based rules (e.g., GDPR, HIPPA, FedRAMP), best practices, common computer data security regulations, or other relevant regulations. Regulation 426 may be based on the location of the source cloud 420. Regulation 426 may be dependent on or independent of the particular location of source cloud 420. Similarly, regulations 436 may be based on the location of the various additional clouds 430, or may be independent of the particular location of a given additional cloud 430.

The source cloud 420 and the additional clouds 430 may each be located in similar or differing geographic locations. Specifically, each cloud object data store may be related to a region or a zone. Each region may be a geographic and/or state-separated unit (e.g., a state, a county, a country, a continent), that includes multiple zones. Each zone may include one or more geographically distinct data centers. Each data center may include a plurality of servers that are configured to host various instances of physical and virtualized computers or computing nodes. The computing nodes may be configured to host object storage for various clients, at distinct security levels or thresholds. For example, source cloud 420 may be located in a first region along with additional cloud 430-2, and additional cloud 430-1 may be located in a second region.

The various components of each cloud object data store may operate at similar or differing security levels. For example, additional cloud 430-1 may operate consistent with regulation 436-1 that may specify a relatively low level of security. Further, source cloud 420 may operate consistent with regulation 426 that may specify a relatively moderate level of security. Some cloud object data stores may operate based on multiple regulations. For example, additional cloud 430-2 may operate consistent with two regulations including regulation 436-2 and regulation 436-3. Certain portions of or components of a particular cloud object data store may operate at a differing security level based on a given regulation. For example, hardware server 432-3 and worker node 434-3 may operate with a relatively high level of security consistent with regulations 436-2. Further continuing the example, hardware servers 432-4 and 432-5, and worker nodes 434-2, 434-4, and 434-5 may operate with a relatively moderate level of security consistent with regulations 436-3. In another example, worker node 434-3 may operate based on a first software-/hardware-based encryption technique, and worker nodes 434-2, 434-4, and 434-5 may operate based on a second encryption technique.

Data blobs 440 may be in the form of object data and may correspond to archived or offloaded user data of a user (not depicted). Data blobs 440 (alternatively, objects 440) may be discrete units of data that are stored in a structurally flat data environment. Specifically, objects 440 may include computer information with no folders, directories, rows, columns, headers, or complex hierarchies, as in a file-based or database-based system. Each object 440 may be a simple, self-contained repository that includes a unique identifier 442-1, 442-2, 442-n (collectively ID 442), metadata 444-1, 444-2, 444-n (collectively metadata 444), and a payload of content 446-1, 446-2, 446-n (collectively content 446). The ID 442 may be a string or relevant value that uniquely identifies each data blob 440 (e.g., ID 442-2 may be a number that is only assigned to data blob 440-2; ID 442-1 may be a string of characters that is unique to data blob 440-1). The metadata 444 may include descriptive information related to the content 446 of a data blob 440 (e.g., metadata 444-1 may state “password” to indicate that content 446-1 is a password; metadata 444-2 may state “pictures folder” to indicate that content 446-2 is a folder of images). The metadata 444 may include user-specific information (e.g., metadata 444-2 may include “user-273019842342345” to associate content 446-2 with a particular user). The metadata 444 may be blank, or not filled out with any information at the time of being stored in source cloud 420.

The processing subsystem 450 of system 400 may be configured to perform CASC. Specifically, the processing subsystem 450 may be configured to detect a migration, such as a pending migration and, responsive to the migration, may be configured to retrieve and scan various data blobs that make up a pending migration, such as data blobs 440. The processing subsystem 450 may be configured to identify various data blobs, such as object data 440 of a pending data migration, and to determine a set of potential target cloud object data stores (“target clouds”) from the additional clouds 430. In particular, the processing subsystem may assign a given additional cloud 430, such as additional cloud 430-2, as a potential target cloud for migration of data blobs, such as data blobs 440.

In some embodiments, the processing subsystem 450 may be implemented as a portion or subcomponent of another element of the system 400. For example, processing subsystem 450 may be a hardware and/or software component that is a part of the source cloud 420. In another example, the processing subsystem 450 may be a hardware and/or software component that is a part of one or more of the additional clouds 430. In some embodiments, the processing subsystem 450 may be implemented as a separate computing instance, such as an instance of computer 100. In some embodiments, the processing subsystem 450 may be implemented as an abstracted computing instance, such as a portion of cloud computing environment 50.

The processing subsystem 450 of system 400 may be configured to perform CASC by performing an entity-relation operation, such as based on records stored in data blobs 440. Performing an entity-relation operation may include the process that resolves entities and detects relationships within a plurality of stored records. Each of the records may include one or more attributes and performance of entity resolution operation may include executing a series of concise rules against the entity received in the request. Performing an entity-relation operation may include processing of records in three phases: recognize, resolve, and relate. The recognition phase may include validating, optimizing, and enhancing the incoming records. During this recognize phase, the records may be cleansed and attributes may be standardized, as well as performance of data quality checks on records to protect the integrity of an entity database within a secure storage. During entity resolution, attributes within the records may be identified as entities. After the attributes in the records have been cleansed, standardized, or enhanced, sophisticated search algorithms may be used to compare the attributes in the incoming record against existing entities in the entity database to determine if they are the same entity. During entity resolution, additional processing may also complete the relationship detection process, which detects relationships between identities and entities and generates alerts for relationships of interest. In some embodiment, scoring may also occur. For example, during entity resolution, it may be determined how closely attributes for an incoming record match the attributes of an existing entity. The results of this computational analysis are scores that may be used to resolve identities into entities and detect relationships between entities.

The processing subsystem 450 may be considered an orchestration layer. Specifically, the processing subsystem 450 may be configured to instruct the following components to perform various operations of CASC. The processing subsystem 450 may include the following: a data classifier 460; a compliance engine 454; and at least one node scheduler 456. The data classifier 452 may be configured to identify one or more security requirements of data blobs, such as data blobs 440. The data classifier 452 may be configured to analyze the metadata 444 of a given data blob 440 to identify security requirements. The data classifier 452 may be configured to analyze the content 446 of a given data blob 440 to identify security requirements. For example, the data classifier 452 may be configured to determine that data blob 440-1 is a text document. In another example, the data classifier 452 may be configured to determine that data blob 440-1 is an encrypted folder of presentation slides. The data classifier 452 may be configured to identify relationships between data blobs 440 to identify security requirements. For example, the data classifier 452 may scan data blob 440-1 and may determine that data blob 440-1 is a repository that is encrypted by a password in data blob 440-2.

The data classifier 452 may include components configured to perform AI. Specifically, the data classifier may include at least the following: a natural language processor (“NLP”) 462; a machine learning component (“MLC”) 464; and a regulation datastore (“regulation DS”) 466. The NLP 462 and the MLC 464 may be trained on the regulation DS 466. Specifically, the regulation DS 466 may include various regulation requirements, jurisdictional policies, configuration settings, encryption polices and other relevant security and guidance information. The regulation DS 466 may be configured in a relational format, such as a set of key-value pairs, a database, or other relevant relational structure. For example, a first example cloud object data store may be stored in the regulation DS 466. The first example cloud object data store may include securing and guidance information that describe a compliant setup, such as a specified encryption level, a geographic location, and a list of mandatory and optional best practices for object blob storage. Further continuing the example, additional example cloud object data stores may include similar securing and guidance information that describe compliant settings for various cloud object data stores.

The natural language processor 462 may include various components (not depicted) operating through hardware, software, or in some combination. For example, the natural language processor 462 may include a physical processor, one or more data sources, a search application, and a report analyzer. The natural language processor 462 may be a computer module that analyses the received content and other information. The natural language processor 462 may perform various methods and techniques for analyzing textual information (e.g., syntactic analysis, semantic analysis, etc.). The natural language processor 462 may be configured to recognize and analyze any number of natural languages. In some embodiments, the natural language processor 462 may parse passages of documents or content from object data, such as data blobs stored in cloud object data stores (e.g., object data 440). Various components (not depicted) of the natural language processor 462 may include, but are not limited to, a tokenizer, a part-of-speech (POS) tagger, a semantic relationship identifier, and a syntactic relationship identifier. The natural language processor 462 may include a support vector machine (SVM) generator to processor the content of topics found within a corpus and classify the topics.

In some embodiments, the tokenizer may be a computer module that performs lexical analyses. The tokenizer may convert a sequence of characters into a sequence of tokens. A token may be a string of characters included in an electronic document and categorized as a meaningful symbol. Further, in some embodiments, the tokenizer may identify word boundaries in an electronic document and break any text passages within the document into their component text elements, such as words, multiword tokens, numbers, and punctuation marks. In some embodiments, the tokenizer may receive a string of characters, identify the lexemes in the string, and categorize them into tokens.

Consistent with various embodiments, the POS tagger may be a computer module that marks up a word in passages to correspond to a particular part of speech. The POS tagger may read a passage or other text in natural language and assign a part of speech to each word or other token. The POS tagger may determine the part of speech to which a word (or other text element) corresponds based on the definition of the word and the context of the word. The context of a word may be based on its relationship with adjacent and related words in a phrase, sentence, or paragraph.

In some embodiments, the context of a word may be dependent on one or more previously analyzed electronic documents (e.g., content 446, metadata 444). Examples of parts of speech that may be assigned to words include, but are not limited to, nouns, verbs, adjectives, adverbs, and the like. Examples of other part of speech categories that POS tagger may assign include, but are not limited to, comparative or superlative adverbs, wh-adverbs, conjunctions, determiners, negative particles, possessive markers, prepositions, wh-pronouns, and the like. In some embodiments, the POS tagger may tag or otherwise annotate tokens of a passage with part of speech categories. In some embodiments, the POS tagger may tag tokens or words of a passage to be parsed by the natural language processing system.

In some embodiments, the semantic relationship identifier may be a computer module that may be configured to identify semantic relationships of recognized text elements (e.g., words, phrases) in documents. In some embodiments, the semantic relationship identifier may determine functional dependencies between entities and other semantic relationships.

Consistent with various embodiments, the syntactic relationship identifier may be a computer module that may be configured to identify syntactic relationships in a passage composed of tokens. The syntactic relationship identifier may determine the grammatical structures of sentences such as, for example, which groups of words are associated as phrases and which word is the subject or object of a verb. The syntactic relationship identifier may conform to formal grammar.

In some embodiments, the natural language processor 462 may be a computer module that may parse a document and generate corresponding data structures for one or more portions of the document. For example, in response to receiving a series of seemingly unrelated data blobs stored on a particular cloud object data store, the natural language processor 462 may output parsed text elements from the data. In some embodiments, a parsed text element may be represented in the form of a parse tree or other graph structure. To generate the parsed text element, the natural language processor 462 may trigger computer modules including the tokenizer, the part-of-speech (POS) tagger, the SVM generator, the semantic relationship identifier, and the syntactic relationship identifier.

The MLC 464 may be a machine-learning model that is configured to analysis data regarding pending migrations of data between cloud object data stores. The MLC 464 may execute machine learning on data using one or more of the following example techniques: k-nearest neighbor (kNN), learning vector quantization (LVQ), self-organizing map (SOM), logistic regression, ordinary least squares regression (OLSR), linear regression, stepwise regression, multivariate adaptive regression spline (MARS), ridge regression, least absolute shrinkage and selection operator (LASSO), elastic net, least-angle regression (LARS), probabilistic classifier, naïve Bayes classifier, binary classifier, linear classifier, hierarchical classifier, canonical correlation analysis (CCA), factor analysis, independent component analysis (ICA), linear discriminant analysis (LDA), multidimensional scaling (MDS), non-negative metric factorization (NMF), partial least squares regression (PLSR), principal component analysis (PCA), principal component regression (PCR), Sammon mapping, t-distributed stochastic neighbor embedding (t-SNE), bootstrap aggregating, ensemble averaging, gradient boosted decision tree (GBRT), gradient boosting machine (GBM), inductive bias algorithms, Q-learning, state-action-reward-state-action (SARSA), temporal difference (TD) learning, apriori algorithms, equivalence class transformation (ECLAT) algorithms, Gaussian process regression, gene expression programming, group method of data handling (GMDH), inductive logic programming, instance-based learning, logistic model trees, information fuzzy networks (IFN), hidden Markov models, Gaussian naïve Bayes, multinomial naïve Bayes, averaged one-dependence estimators (AODE), Bayesian network (BN), classification and regression tree (CART), chi-squared automatic interaction detection (CHAID), expectation-maximization algorithm, feedforward neural networks, logic learning machine, self-organizing map, single-linkage clustering, fuzzy clustering, hierarchical clustering, Boltzmann machines, convolutional neural networks, recurrent neural networks, hierarchical temporal memory (HTM), and/or other machine learning techniques.

The data classifier 452 may be configured to determine a set of potential target cloud object data stores from the set of additional clouds 430. For example, based on the NLP 462 and the MLC 464, the data classifier 452 may determine that data blobs 440 may be migrated to one or more of the additional clouds 430 while maintaining a security requirement of the data blobs 440. The data classifier 452 may also assign a potential target cloud of the set of additional clouds 430 to be a target cloud object data store for the data migration. For example, based on identifying that a security standard performed by worker node 434-6 may be consistent with the security requirements of data blobs 440, the data classifier 452 may assign worker node 434-6 to host data blobs 440. The data classifier may assign a potential target cloud by labeling the data blobs. The data blobs 440 may be assigned by labeling the data blobs with a particular target cloud. For example, data blobs 440 may be labeled by inserting “-nodes 434-3 434-4” into metadata 444, wherein worker nodes 434-3 and 434-4 are the assigned worker nodes of target cloud 430-2. The data blobs 440 may be assigned by labeling the data blobs with a particular level of security requirement, such as “-security level =high”, “-encryption SSH” or some other relevant security requirement. The data classifier 452 may assign a potential target cloud by instructing or directing the data blobs to a particular node (e.g., by instructing the node scheduler 456).

The compliance engine 454 of the processing subsystem 450 may analyze the data blobs of a pending migration and may perform additional modifications and/or updates to the data blobs before and/or during migration. The compliance engine 454 may analyze the data blobs and may determine a security requirement for the data blobs of the pending migration. In some embodiments, the compliance engine 454 may analyze the data blobs after they are assigned by the data classifier 452. For example, the compliance engine 454 may identify one or more regulations that indicate specific types of service level agreements and/or computer security certificates that may be associated with a particular security requirement in labeled data blobs 440. The compliance engine 454 may perform the additional modifications directly. For example, a certificate that states “openssl req-x509-nodes-days 730-newkey rsa:2048-keyout server. key-out server.crt -config req.conf-extensions ‘v3_req’” May be created by the compliance engine 454. The compliance engine 454 may instruct another component of system 400 (e.g., the processing subsystem 450, the node schedule 456, a target cloud of the additional clouds 430) to perform the additional modifications to the data blobs.

The node scheduler 456 may distribute the classified and labeled data blobs to one or more of the target nodes. For example, after the data classifier 452 and/or the compliance engine 454 assign and update data blobs 440, to a particular additional cloud 430, the node scheduler 456 may actually migrate and/or instruct a given worker node 434 to perform hosting and processing of data blob 440. The node scheduler 456 may exist entirely within the processing subsystem 450. The node scheduler 456 may be instanced on each of the source node 420 and additional nodes 430. For example, a first node scheduler (not depicted) may operate for the source node 420 and an additional one or more node schedulers (not depicted) may operate for the additional clouds 434. The node scheduler 456 may assign or migrate data blobs based on the metadata 44. For example, in response to data blob 440-2 including “-security level=high” in metadata 444-2, the node scheduler 456 may migrate data blob 440-2, to cloud 430-1 that is configured to perform a relatively high level of security. The selection by the node scheduler 456, may be based on the incoming or migrating data blobs being similar to existing data blobs, such as incoming data blobs having a particular encryption as a security requirement, and a given another cloud 430 hosting existing data blobs that have the particular encryption.

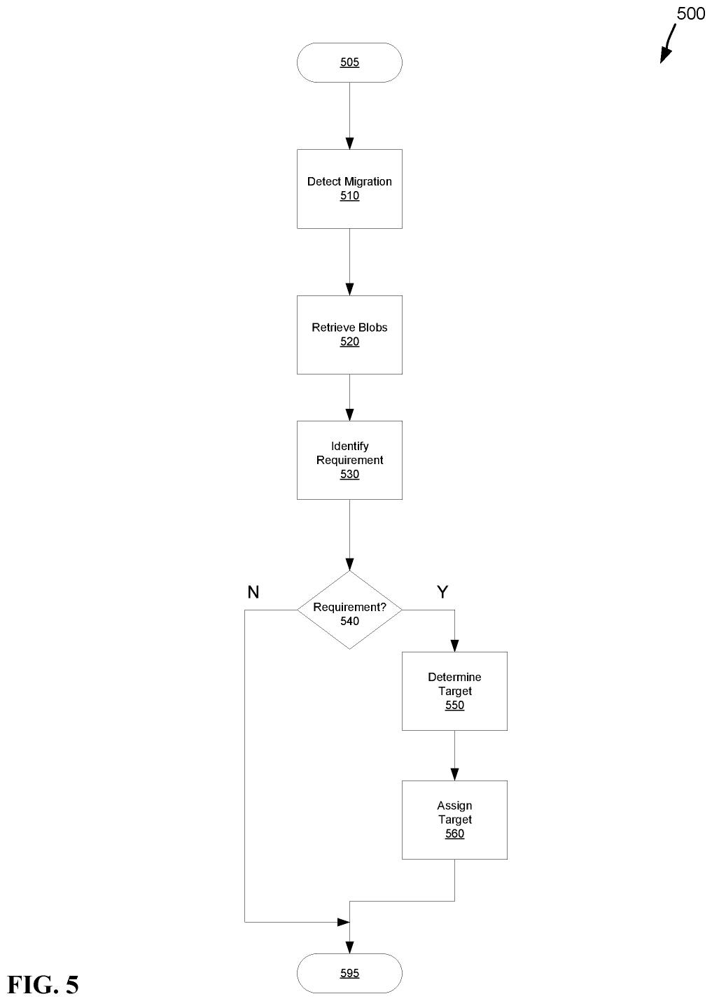

FIG. 5 depicts an example method 500 of performing data migration of cloud objects, consistent with some embodiments of the disclosure. Specifically, method 500 may be configured to perform one or more operations of CASC. Method 500 may generally be implemented in fixed-functionality hardware, configurable logic, logic instructions, etc., or any combination thereof. For example, the logic instructions might include assembler instructions, instruction-set-architecture (ISA) instructions, machine instructions, machine dependent instructions, microcode, state-setting data, configuration data for integrated circuitry, state information that personalizes electronic circuitry, and/or other structural components that are native to hardware (e.g., host processor, central processing unit/CPU, microcontroller, etc.).

Method 500 begins at 505, by detecting a data migration 510. The data migration 510 may be a pending data migration, and the detecting may include monitoring of cloud object data stores (“cloud stores”). The cloud stores may include data that has been requested to be migrated to another cloud, and the cloud store in this situation may be considered a source cloud store. For example, CASC may be operating as one or more processing systems, such as processing subsystem 450. Each processing system may be instanced on each cloud store across a plurality of cloud stores. The detecting may include receiving a request from a cloud store. for example, a processing system that performs CASC may operate separately from a number of cloud stores, such as a designated computing component configured to receive and respond to requests for data migrations.

At 520, one or more data blobs (e.g., data blobs 440) may be retrieved. The retrieved data blobs may be data blobs associated with a pending migration. For instance, based on a pending migration request that is determined at 510, all of the data blobs that are associated with the data migration may be retrieved from a source cloud store that is currently hosting the data blobs. Along with retrieving of the data blobs, one or more existing configuration and hosting information may be retrieved. For example, information regarding the current storage, encryption, security, processing, or other relevant information from the source cloud store may also be retrieved with the data blobs.

At 530, a security requirement may be identified for the data blobs. The security requirement may be identified based on the source cloud store. In detail, the particular information that is retrieved, at 510, that is related to the source cloud store may be analyzed. The analysis may include performing NLP, ML, or another relevant AI technique on the retrieved configuration information to identify a security requirement of the data blobs. The security requirement may be identified based on the data blobs. In detail, the retrieved data blobs may be scanned and analyzed to identify a security requirement. The analysis may include performing one or more AI techniques on the data blobs, such as NLP and/or ML. The identification may be based on the content of the data blobs, such as determining names, dates, medical conditions, etc., contained in the data blobs. The identification may be based on metadata of the data blobs. For example, the identification may include identifying metadata that indicates data blobs are text, photos, directories, and/or database entries. In another example, the identification may include identifying metadata that indicates data blobs specify a certain regulation requirement of a regulation body, security certificate, and/or an encryption technique.

The identification, at 530, may include identifying a particular relationship between various data blobs. For example, identifying a password in a first data blob, and metadata indicating the password is related to a second data blob, may indicate that first data blob and the second data blob should be encrypted while being stored as data blobs. The identification may include processing the data to determine a relationship between various data blobs that indicate a security requirement. For example, a first set of data blobs may be restored to a temporary data store to indicate that various records are hierarchical files/folders, and that a second set of data blobs contain a password related to the first set of data blobs. Further, the processing may include executing an encryption or decryption technique to identify a successful encryption and/or decryption of the first set of data blobs using the password represented by the second set of data blobs.

If the security requirement is identified, at 540:Y, method 500 may continue by determining a set of potential target cloud object data stores (“target cloud stores”) at 550. The potential target cloud stores may be determined based on the security requirement. For example, the potential target cloud stores may be determined by matching the compliance of additional cloud stores with various security requirements, including a security requirement of the data blobs. The potential target cloud stores may be determined by identifying only a single potential target cloud store that complies with the security requirements. The potential target cloud stores may be determined by identifying only a plurality potential target cloud store that complies with the security requirements. The potential target cloud stores may be determined by not identifying any single target cloud store that complies with the security requirements.

At 560 the set of data blobs may be assigned to a first potential target data store of the set of potential target cloud stores. The assigning may include labeling the pending data migration with classification information, such as the security requirements. The classification information may identify the first potential target cloud object data store specifically. The assigning may include assigning the data blobs to a particular worker node of a set of one or more potential target clouds. The assigning may include migrating, moving, replicating, or otherwise transferring the data blobs to the potential target data store. The assigning may include provisioning a new target cloud. For example, if a potential target cloud is not identified that complies with the security requirements, a new instance of a target cloud may be provisioned that complies with the security requirements.

After the set of data blobs are assigned at 560 (or if there is no security requirement identified at 540:N), method 500 may end at 595.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A method comprising:
detecting a pending data migration, wherein the pending data migration is related to a set of one or more data blobs, and wherein the set of data blobs is stored on a source cloud object data store;
retrieving, from the source cloud object data store, the set of data blobs;
identifying, based on the set of data blobs and based on the source cloud object data store, a security requirement for the set of data blobs;
determining, based on the security requirement and in response to the pending data migration, a set of one or more potential target cloud object data stores from a set of additional cloud object data stores; and
assigning, in response to the determining and based on the security requirement, the set of data blobs to a first potential target cloud object data store of the set of potential target cloud object data stores.

2. The method of claim 1, wherein:
the pending data migration is detected by the source cloud object data store, and
the determining the set of potential target cloud object data stores is performed by the source cloud object data store.

3. The method of claim 1, wherein the identifying the security requirement is based on one or more artificial intelligence operations.

4. The method of claim 3, wherein the identifying includes performing a natural language processing on the set of data blobs.

5. The method of claim 3, wherein the identifying includes performing a machine learning operation on the set of data blobs.

6. The method of claim 1, wherein the identifying the security requirement comprises:
classifying, based on a regulation requirement, the set of data blobs, wherein the regulation requirement is related to a regulation body.

7. The method of claim 1, wherein the identifying the security requirement comprises:
identifying a password in a first data blob of the set of data blobs; and
determining the password is associated with data stored in the set of data blobs.

8. The method of claim 1, wherein the identifying the security requirement comprises:
identifying an encryption technique used to encrypt the set of data blobs in the source cloud object data store.

9. The method of claim 1, wherein the assigning the set of data blobs comprises:
labeling, based on the security requirement, the pending data migration with a classification label.

10. The method of claim 9, wherein the classification label identifies the first potential target cloud object data store.

11. The method of claim 10, wherein the classification label identifies a first subset of potential target cloud object data stores that includes the first potential target cloud object data store.

12. The method of claim 9, wherein the classification label includes the security requirement.

13. The method of claim 1, wherein the method further comprises:
migrating the set of data blobs to the first potential target cloud object data store.

14. The method of claim 1, wherein the assigning the set of data blobs includes:
assigning the set of data blobs to a first worker node of a set of worker nodes of the first potential target cloud object data store.

15. A system, the system comprising:
a memory, the memory containing one or more instructions; and
a processor, the processor communicatively coupled to the memory, the processor, in response to reading the one or more instructions, configured to:
detect a pending data migration, wherein the pending data migration is related to a set of one or more data blobs, wherein the set of data blobs are stored on a source cloud object data store;
retrieve, from the source cloud object data store, the set of data blobs;
identify, based on the set of data blobs and based on the source cloud object data store, a security requirement for the set of data blobs;
determine, based on the security requirement and based on the pending data migration, a set of one or more potential target cloud object data stores from a set of additional cloud object data stores; and
assign, in response to the determining and based on the security requirement, the set of data blobs to a first potential target cloud object data store of the set of potential target cloud object data stores.

16. The system of claim 15, wherein:
the pending data migration is detected by the source cloud object data store, and
the determining the set of potential target cloud object data stores is performed by the source cloud object data store.

17. The system of claim 15, wherein the identifying the security requirement is based on one or more artificial intelligence operations.

18. A computer program product, the computer program product comprising:
one or more computer readable storage media; and
program instructions collectively stored on the one or more computer readable storage media, the program instructions configured to:
detect a pending data migration, wherein the pending data migration is related to a set of one or more data blobs, wherein the set of data blobs are stored on a source cloud object data store;
retrieve, from the source cloud object data store, the set of data blobs;
identify, based on the set of data blobs and based on the source cloud object data store, a security requirement for the set of data blobs;
determine, based on the security requirement and based on the pending data migration, a set of one or more potential target cloud object data stores from a set of additional cloud object data stores; and
assign, in response to the determining and based on the security requirement, the set of data blobs to a first potential target cloud object data store of the set of potential target cloud object data stores.

19. The computer program product of claim 18, wherein:
the pending data migration is detected by the source cloud object data store, and
the determining the set of potential target cloud object data stores is performed by the source cloud object data store.

20. The computer program product of claim 18, wherein the identifying the security requirement is based on one or more artificial intelligence operations.
